(19) United States
(12) Patent Application Publication
(10) Pub. No.: US 2007/0022622 A1
(43) Pub. Date: Feb. 1, 2007

(54) Freeze drying apparatus

(76) Inventors: Ivan Haynes Lanaway, Ransomville, NY (US); Ernesto Renzi, Youngstown, NY (US)

Correspondence Address: THE BOC GROUP, INC., 575 MOUNTAIN AVENUE, MURRAY HILL, NJ, 07974-2064, US

(21) Appl. No.: 11/189,532

(22) Filed: Jul. 26, 2005

(51) Int. Cl. F26B 13/30; F26B 5/04

(52) U.S. Cl. 34/92; 34/406

(57) ABSTRACT

Freeze drying apparatus is described, the freeze drying apparatus comprising freezing apparatus for freezing a liquid component of a sample into a solid, a mobile drying chamber for receiving samples from the freezing apparatus, a condensation chamber comprising a condenser, a condenser conduit system comprising an outlet connected to the condensation chamber, an inlet for connection to the drying chamber, and an isolation valve for selectively isolating the inlet from the outlet, an evacuation system for evacuating the drying chamber, and a thermal control system for controlling the temperature of the samples located within the drying chamber. The drying chamber is moveable between a first location at which samples are transferred from the freezing apparatus to the chamber, and a second location at which the chamber is connected to the inlet of the condenser conduit system.

### FIELD OF THE INVENTION

The present invention relates to freeze drying apparatus.

### BACKGROUND OF THE INVENTION

Freeze drying is a process that removes water from a sample by sublimation of frozen water. Freeze drying is particularly useful in the pharmaceutical industry, as the integrity of the samples is preserved during the freeze drying process and sample stability can be guaranteed over relatively long periods of time.

One known type of freeze drying apparatus for producing pharmaceutical tablets comprises a freezing apparatus for receiving a sheet, tray or blister pack having a number of depressions each containing a liquid pharmaceutical sample to be freeze dried, and for refrigerating the blister pack to freeze the samples, for example, by exposing the samples to liquid nitrogen or liquid carbon dioxide. The sheet is then conveyed from the freezing apparatus to a drying chamber. The drying chamber usually includes a number of heating shelves, each of which could be raised and lowered within the chamber relative to a loading position at which the sheet can be loaded on to the shelf. Access to the chamber for automated loading and removal of the sheet is generally through an opening formed in a wall or in the main door of the chamber. Fixed shelves with manual loading or alternative loading systems are also adopted.

In the drying process, the temperature of the drying chamber is initially reduced to a temperature below the samples freezing temperature so that the water within the samples remains frozen during loading of the chamber. Following loading, the opening to the chamber is closed. The chamber is evacuated to a pressure typically below 1 mbar, and the shelves are heated to cause the ice within the samples to sublimate into water vapour. A duct connected to the drying chamber conveys the water vapour to a condensation chamber containing a cold condenser. Ice condensed within the condenser chamber can be removed at a later stage. The driving force for the water vapour transport is the pressure difference between the drying chamber and the condensation chamber. This pressure difference is caused by the fact that the condensation chamber is maintained at a lower temperature than the samples. A vacuum pump is usually provided downstream from the condensation chamber to serve as a facilitating element for the transport of water vapour from the drying chamber to the condensation chamber, in terms of minimising the ‘mean free path length’.

Following the completion of the drying process, the drying chamber is pressurised back to atmospheric pressure, and the sheet, now containing solid pharmaceutical tablets, is then unloaded from the drying chamber, and transferred to a packaging station, for example, for removal of the tablets from the depressions for bottling, or by sealing of the depressions by application of a film to the sheet to enclose the tablets.

An important issue in the use of such freeze drying apparatus is that the water within the samples should remain in a frozen state as the sheet is transferred from the freezing apparatus to the drying chamber. For this purpose, the sheet is typically transferred from the freezing apparatus into a first, refrigerated transfer vehicle. The first transfer vehicle is then moved to a position adjacent the opening of the drying chamber, and from which the sheet is loaded into the drying chamber. Once the drying of the samples has been completed, the sheet is transferred to a second transfer vehicle, which is then moved to the packaging station. However, due to the exposure of the samples to the ambient atmosphere as they are transferred from the first transfer vehicle to the drying chamber, there is a risk that some of the ice within the samples may melt, thereby reducing the efficiency of the subsequent drying process.

It is an aim of at least the preferred embodiment of the present invention to seek to solve these and other problems.

### SUMMARY OF THE INVENTION

In a first aspect, the present invention provides freeze drying apparatus comprising a mobile drying chamber for receiving samples, and a condenser, wherein the drying chamber is moveable between a first location at which samples are loaded thereinto, and a second location at which the chamber is connected to the condenser.

In a second aspect, the present invention provides freeze drying apparatus comprising freezing apparatus for freezing a liquid component of a sample into a solid, a mobile drying chamber for receiving samples from the freezing apparatus, a condenser, a condenser conduit system for conveying vapour from the drying chamber to the condenser, the condenser conduit system comprising an inlet for connection to the drying chamber, and an isolation valve for selectively isolating the inlet from the condenser, an evacuation system for evacuating the drying chamber; and a thermal control system for controlling the temperature of the samples located within the drying chamber; wherein the drying chamber is moveable between a first location at which samples are transferred from the freezing apparatus to the chamber, and a second location at which the chamber is connected to the inlet of the condenser conduit system.

By conducting the drying of the samples, for example pharmaceutical samples such as tablets, within a mobile drying chamber that receives frozen samples from the freezing apparatus, the risk of any ice melting within the samples can be significantly reduced, as the step of transferring the samples from the mobile chamber to a conventional drying apparatus is eliminated. With the conventional drying chamber and second transport vehicle for transporting samples from the conventional drying chamber therefore being no longer required, the number of components of the freeze drying apparatus can also be reduced in comparison to the prior art apparatus.

The mobile drying chamber may be manually moved between locations, for example by providing the drying chamber with wheels to enable an operator to push the drying chamber between locations. Alternatively, the mobile drying chamber may be moved between locations by an automated guided vehicle (AGV) system. Following the completion of the drying process, the drying chamber can be disconnected from the condenser and moved to a third location at which the samples are unloaded from the drying chamber for packaging, for example, either individually or in bottles.

In a preferred embodiment, the evacuation system is configured to evacuate the drying chamber via the inlet of the condenser conduit system, and preferably through the condenser, thereby minimising the number of connections that need to be made to the drying chamber at the second location.

A drying chamber pre-evacuation system is preferably provided for at least partially evacuating the drying chamber before the drying chamber is connected to the evacuation system. This can enable the drying chamber to be pre-evacuated to the operating pressure of the condensation conduit system and condenser before the isolation valve is opened to expose the drying chamber to the evacuation system. The pre-evacuation system preferably comprises a vacuum pump, and a vacuum conduit system comprising an inlet connected to the condenser conduit system, an outlet connected to the vacuum pump, and an isolation valve for selectively isolating the inlet of the vacuum conduit system from the outlet of the vacuum conduit system. As a result, the number of connections that need to be made to the drying chamber at the second location may be minimised.

The thermal control system preferably comprises heating apparatus for heating the samples located within the drying chamber to cause the solid to sublime into vapour and/or to complete the drying process. The drying chamber may be provided with an integral heating apparatus, for example, to heat shelves upon which the samples are located within the chamber. Alternatively, the drying chamber may be connected to external heating apparatus at the second location. The external heating apparatus may comprise a source of a heated fluid, such as one of silicone oil and a mixture of water and glycol, and means for selectively conveying the heated fluid to the drying chamber to increase the temperature of the samples therein.

The mobile drying chamber may be thermally insulated to maintain the liquid component of the frozen sample in solid form until drying of the sample is to be commenced. Alternatively, or additionally, the thermal control system may comprise cooling apparatus for maintaining the liquid component of the frozen samples located within the drying chamber as a solid. The drying chamber may be provided with an integral cooling apparatus, for example, to cool the shelves upon which the samples are located within the chamber. Alternatively, the thermal control apparatus may be an external apparatus connectable to the drying chamber at the first location so that the liquid component of the samples remains frozen as the samples are transferred from the freezing apparatus into the drying chamber, and/or at the second location so that the liquid component of the samples remains frozen until the drying process is commenced. The external cooling apparatus may comprise a source of a coolant, and means for selectively conveying the coolant to the drying chamber.

An isolation valve may be provided for selectively isolating the condenser from the condenser conduit system. In order to provide redundancy to enable the condenser to be periodically serviced by defrosting, emptying of liquid and cleaning, the apparatus may comprise an additional condenser, and an additional isolation valve for selectively isolating the additional condenser from the condenser conduit system. This enables one of the condensers to receive the vapour from the drying chamber while the other is being serviced, thereby enabling servicing to be performed without interrupting use of the freeze drying apparatus.

In a preferred embodiment, the drying chamber has an opening through which the samples are transferred into the chamber from the freezing apparatus, and a door for closing the opening, the door having a slot formed therein for exposing part of the opening, and wherein the freeze drying apparatus comprises means for moving the door in a direction transverse to the opening. The moving means preferably comprises means for raising and lowering the door. In order to expose only a limited number of shelves within the drying chamber when samples are transferred to the chamber, the drying chamber preferably comprises a flexible screen attached to one end of the door, and a reel located beneath the opening and from which the flexible screen is unwound as the door is raised. This screen serves to reduce heat loss from the chamber as the end of the door is raised above the bottom edge of the opening of the chamber.

The moving means is preferably located at the second location, and preferably comprises means for releasably engaging the door.

Additional mobile chambers may be provided to permit the use of the freeze-drying apparatus to be substantially continuous. For example, while one chamber is being loaded with samples at the first location, other chambers may be located at the second location for drying the frozen samples, located at the third position for unloading of the dried samples, being cleaned, and/or being cooled in readiness for receiving samples from the freezing apparatus.

The conduit system may be configured to have a plurality of inlets each being selectively connectable to a respective drying chamber thereby to enable a plurality of drying chambers to be connected to the condensation chamber for drying. In this case, a plurality of isolation valves are preferably provided, each for selectively isolating a respective inlet from the outlet, with the drying chamber evacuation system being configured to evacuate each of the drying chambers at the second location.

A vacuum pump may be provided for each drying chamber to enable the pressure within a drying chamber to be reduced to the pressure within the condenser conduit system before the respective isolation valve is opened to operatively connect that drying chamber to the condenser. Alternatively, a pre-evacuation system may comprise a vacuum pump, and a vacuum conduit system comprising a plurality of inlets each connected to the condenser conduit system between a respective inlet of the condenser conduit system and a respective isolation valve of the condenser conduit system, an outlet connected to the vacuum pump, and a plurality of isolation valves each for selectively isolating a respective inlet of the vacuum conduit system from the outlet of the vacuum conduit system. By providing a common vacuum pump for evacuating each of the mobile chambers at the second location, costs can be reduced.

In a third aspect, the present invention provides freeze drying apparatus comprising freezing apparatus for freezing a liquid component of a sample into a solid, a plurality of mobile drying chambers for receiving samples from the freezing apparatus; a condenser, a condenser conduit system comprising a plurality of inlets each being selectively connectable to a respective drying chamber, and a plurality of isolation valves each for selectively isolating a respective inlet from the condenser; an evacuation system for evacuating the drying chambers; and a thermal control system for controlling the temperature of the samples located within the drying chambers; wherein each drying chamber is moveable between a first location at which samples are transferred from the freezing apparatus to the chamber, and a second location at which the chamber is connected to an inlet of the condenser conduit system.

In a fourth aspect the present invention provides freeze drying apparatus comprising a drying chamber having an opening formed therein for providing access to the chamber and a door for closing the opening, the door having a slot formed therein; and means for raising the door in a direction transverse to the opening so that the slot exposes part of the opening to permit samples to be loaded into the chamber; the drying chamber comprising a flexible screen attached to a bottom end of the door and a reel located beneath the opening and from which the flexible screen is unwound as the door is raised.

### BRIEF DESCRIPTION OF THE DRAWINGS

Preferred features of the present invention will now be described with reference to the accompanying drawing, in which

FIG. 1 is a plan view of a freeze drying apparatus;

FIGS. 2(a) and 2(b) are side and front views respectively of a mobile drying chamber of the apparatus of FIG. 1;

FIG. 2(c) illustrates a front view of the mobile drying chamber of FIGS. 2(a) and (b) with its door raised;

FIG. 3 is a side view of part of the apparatus of FIG. 1;

FIG. 4 is a schematic view of part of the apparatus of FIG. 1; and

FIGS. 5(a) and (b) illustrate the connection of the drying chamber to the inlet of the condenser conduit system of the apparatus of FIG. 1.

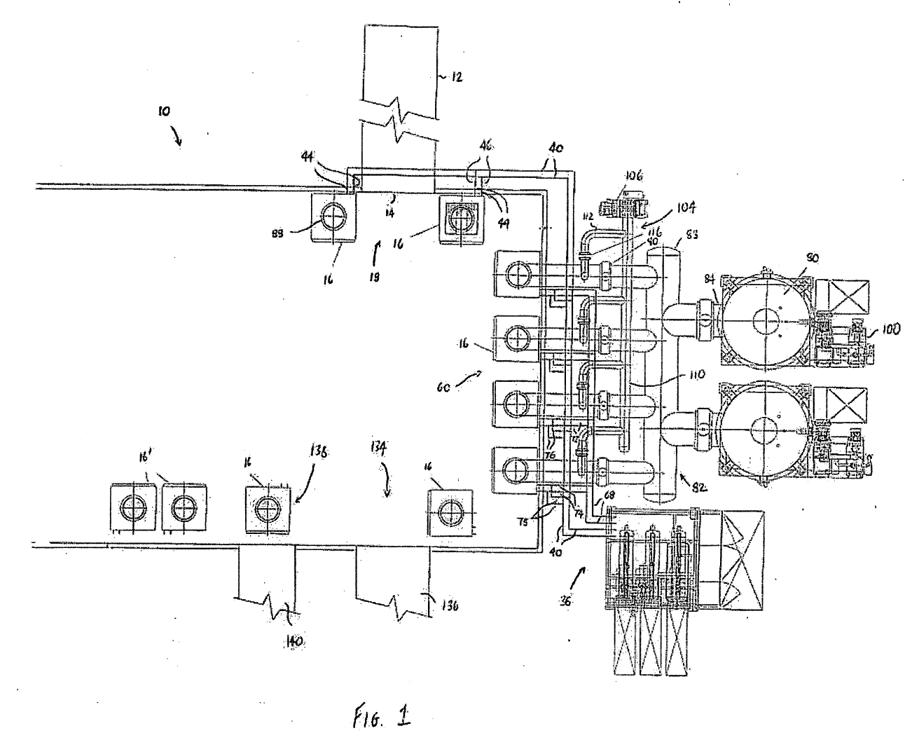

With reference first to FIG. 1, a freeze drying apparatus 10 comprises a freezing apparatus 12 for freezing samples to be freeze dried. In the preferred embodiment, the samples are liquid pharmaceutical samples, which may be located within depressions of a sheet, tray or blister pack having a number of depressions each containing a liquid pharmaceutical sample to be freeze dried. The freezing apparatus 12 may be any suitable apparatus for refrigerating the blister pack to freeze the samples, for example, a liquid nitrogen tunnel which exposes the samples to liquid nitrogen to freeze a liquid component of the samples. This liquid component of the samples is typically water.

An automated manipulator (not shown) is located at the outlet 14 of the freezing apparatus 12 for transferring frozen samples from the freezing apparatus 12 into one or more mobile drying chambers 16 located at a first, loading location, indicated generally by arrow 18 in FIG. 1, proximate the outlet 14 of the freezing apparatus 12. The manipulator may be positioned relative to the outlet 14 of the freezing apparatus such that two drying chambers 16 may be located simultaneously at the loading location 18, one on either side of the outlet 14. The manipulator starts loading frozen samples, generally one blister tray at a time, into one drying chamber, and when that drying chamber is full the manipulator starts loading frozen samples into the other drying chamber. Alternatively, the blister packs may be manually loaded into the drying chambers.

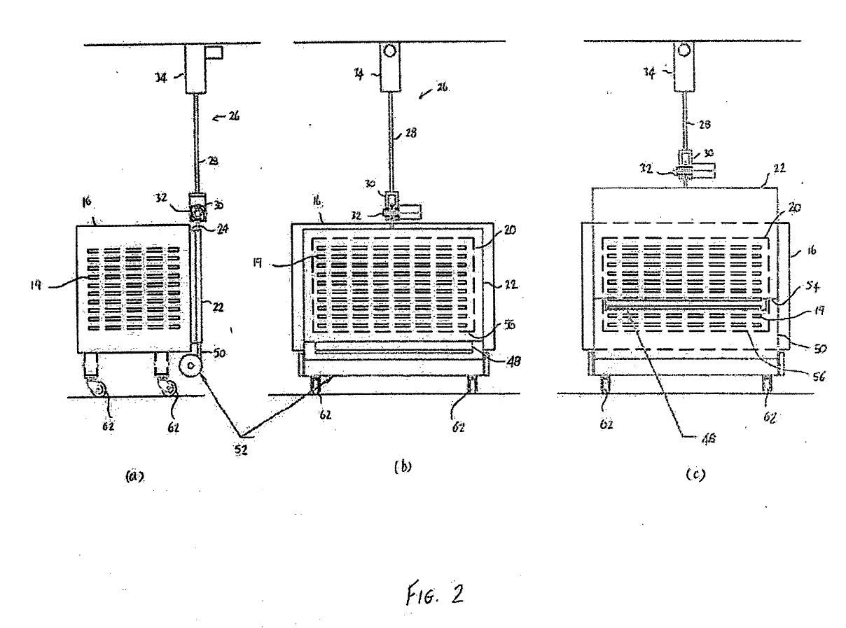

With reference to FIG. 2, each drying chamber 16 comprises a plurality of shelves 19 for receiving the frozen samples. In the preferred embodiment, each drying chamber 16 comprises around 25 shelves, each for receiving several blister packs, although the drying chambers 16 may be provided with any number of shelves and any desired capacity.

Each drying chamber 16 is loaded through an opening 20 formed in one side of the chamber 16. The drying chamber 16 comprises a door 22 for closing the opening 20 to isolate the shelves 19 from the external environment. FIGS. 2(a) and 2(b) illustrate the door 22 in a lowered, closed position in which the door 22 is positioned adjacent the opening 20. One or more seals 24 may be located about the opening 20 to form an air-tight seal with the door 22.

To enable the frozen samples to be loaded into the drying chamber 16, the door 22 is raised to expose one or more shelves 19 of the drying chamber 16 at any given time. A mechanism 26 for raising and lowering the door 22 relative to the drying chamber 16 is located at the loading location 18. The moving mechanism 26 comprises an arm 28 having a latch 32 located at the lower end thereof for releasably engaging a catch 30 connected to the upper end of the door 22. A drive motor 34 is connected to the arm 28 to enable the latch 32 to be selectively raised and lowered, and thereby raise and lower the door 22.

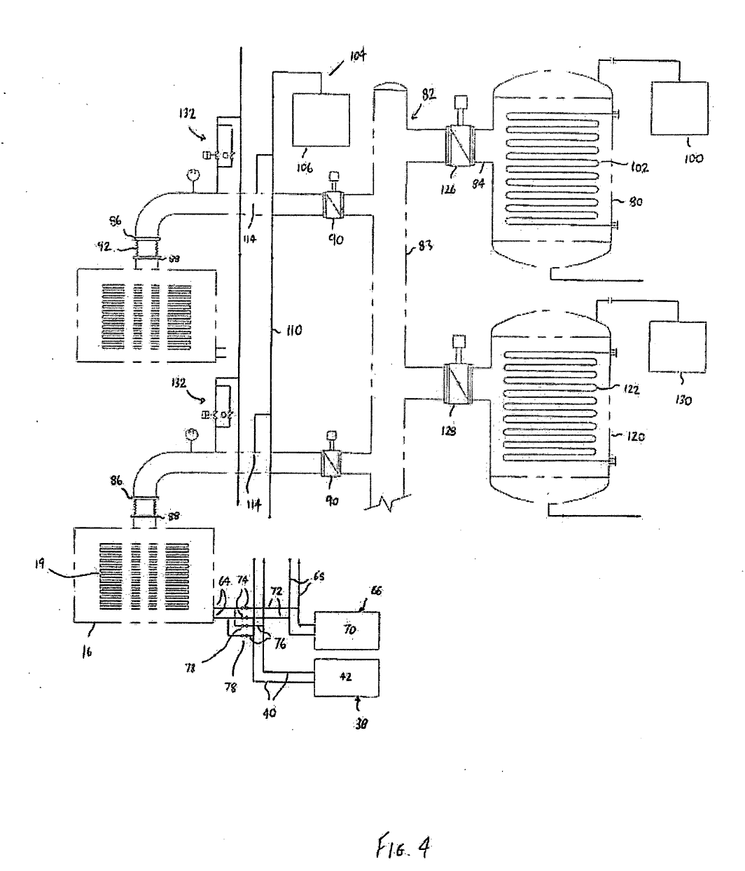

In order to maintain the liquid component of the samples loaded into the drying chamber 16 as a solid until the drying process is started, the shelves 19 are chilled prior to the loading of the samples into the drying chamber 16. Returning to FIG. 1, at the first location the drying chamber 16 is connected to an external thermal control system 36 for controlling the temperature of the drying chamber 16. With reference also to FIG. 4, the thermal control system 36 comprises cooling apparatus 38 for conveying a stream of coolant to the drying chamber 16. The cooling apparatus 38 comprises a coolant conduit system 40 for conveying coolant from a coolant source 42 to the loading location 18, and for subsequently returning the coolant to the coolant source 42 for re-cooling and recirculation. The coolant is preferably a fluid, such as one of silicone oil and a mixture of water and glycol, cooled using liquid nitrogen or a mechanical refrigeration system typically comprising refrigeration compressors. A plurality of sets of branch conduits 44 branching off from the coolant conduit system 40 are provided at the loading location 18, each for connection to a self-sealing fluid inlet port and a self-sealing fluid outlet port of a respective drying chamber 16 positioned at the loading location 18 to convey coolant to the drying chamber 16. The supply of coolant to and from the drying chamber 16 is controlled using valves 46 provided within the branch conduits 44.

Returning to FIG. 2, a slot 48 is formed in the door 22 of the drying chamber 16. With the door 22 in the lowered, closed position illustrated in FIGS. 2(a) and (b), the slot 48 is positioned beneath the opening 20 so that the shelves 19, and therefore any frozen samples located on the shelves, are isolated from the ambient atmosphere. When frozen samples are to be loaded into the drying chamber 16, the latch 32 of the moving mechanism 26 is connected to the catch 30 on the door 22, and the motor 34 is operated to raise the door 22. As the door 22 is raised, the slot 48 sequentially exposes each of the shelves 19 of the drying chamber 16 in turn, starting with the lowermost shelf. As a shelf 19 is exposed by the slot 48, the manipulator loads frozen blister packs onto the exposed shelf.

In order to minimise heating of the drying chamber 16 as the door 22 is raised to expose the shelves 19, the drying chamber 16 comprises a flexible screen 50 attached to the lower end of the door 22, and a reel 52 located beneath the opening 20 and from which the flexible screen 50 is unwound as the door 22 is raised. As illustrated in FIG. 2(c), this flexible screen 50 serves to cover loaded shelves, and thus reduce heat loss from the frozen samples located on those shelves, as the lower end 54 of the door 22 is raised above the bottom edge 56 of the opening 20 of the drying chamber 16.

Once the uppermost shelf has been loaded, the motor 34 is reversed to lower the door 22 to the closed position illustrated in FIGS. 2(a) and 2(b). The valves 46 are closed, and the drying chamber 16 is disconnected from the thermal control system 36. The drying chamber 16 may be thermally insulated to maintain the liquid component of the frozen samples within the drying chamber 16 in solid form until drying of the samples is to be commenced. The drying chamber 16 is then moved from the loading location 18 to a second, drying location, indicated generally at 60 in FIG. 1, where drying of the frozen samples is to be conducted. With reference to FIG. 2, each drying chamber 16 may be mounted on wheels 62 to enable the drying chamber 16 to be moved between locations of the freeze drying apparatus 10. The drying chambers 16 may be moved manually, or may be moved using an automated guided vehicle (AGV) system.

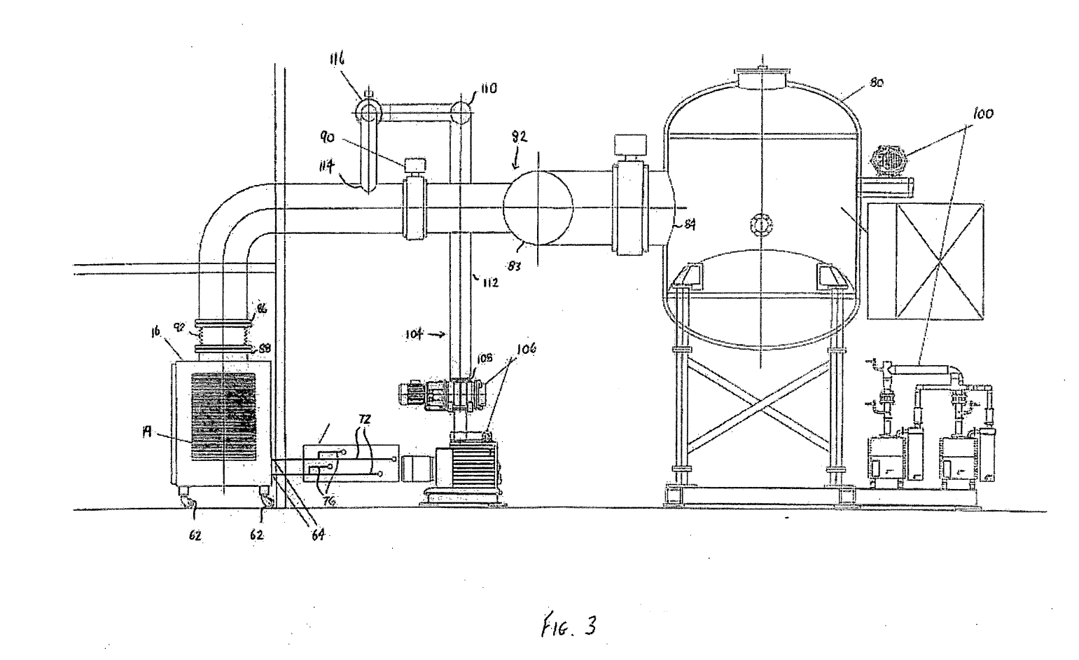

As illustrated in FIGS. 3 and 4, a plurality of drying chambers 16 may be simultaneously positioned at the drying location 60 for simultaneous drying of the frozen samples therein. In the illustrated embodiment, up to four drying chambers 16 may be positioned at the drying location 60 at any given time, although this number may be increased or decreased as required. When positioned at the drying location 60, the fluid inlet and outlet ports 64 of the drying chamber 16 are re-connected to the thermal control system 36. As illustrated in FIGS. 3 and 4, the thermal control system 36 is arranged to convey a selected one of the coolant or a heated fluid to the drying chamber 16 at the drying location to control the temperature of the samples located within the drying chamber 16. In addition to the cooling apparatus 38 previously described, the thermal control system 36 further includes heating apparatus 66 for selectively heating the samples located within the drying chamber 16. The heating apparatus 66 comprises a heated fluid conduit system 68 for conveying heated fluid from a source 70 thereof to the drying location 60, and for subsequently returning the fluid to the source 70 for re-heating and recirculation. The fluid may be a similar fluid to the coolant, such as one of silicone oil and a mixture of water and glycol, heated using steam. A plurality of sets of first branch conduits 72 branching off from the heated fluid conduit system 68 are provided at the drying location 60 each for connection to the fluid ports 64 of a respective drying chamber 16 positioned at the drying location 60 to convey heated fluid to and from the drying chamber 16. The supply of heated fluid to and from the drying chamber 16 is controlled using valves 74 provided within the first branch conduits 72.

In addition to the first branch conduits 72, a plurality of sets of second branch conduits 76 are also provided at the drying location 60, each set branching off from the coolant conduit system 40 and being connected to a respective set of first branch conduits 72 to convey coolant to the drying chamber 16 at the drying location 60.

The supply of coolant to and from the drying chamber 16 is controlled using valves 78 provided within the second branch conduits 76. Initially, valves 74 and 78 are closed. When the ports 64 of the drying chamber have been connected to the thermal control system 36, valves 78 are opened to supply coolant to the drying chamber, and thus maintain the liquid component of the samples located within the drying chamber 16 as a solid until the start of the drying process.

With reference to FIGS. 1, 3 and 4, following the connection of the ports 64 of the drying chamber 16 to the thermal control system 36, the drying chamber 16 is connected to a condensation chamber 80 for receiving vapour drawn from the frozen samples during the drying process. A condenser conduit system 82 for conveying vapour from the drying chambers to the condensation chamber 80 comprises a manifold 83 having an outlet 84 connected to the condensation chamber 80, a plurality of flanged inlets 86 each being selectively connectable to a respective flanged vapour outlet 88 of a drying chamber 16 from which vapour is exhaust from the drying chamber 16 during the drying process, and a plurality of isolation valves 90 each located between the manifold and a respective inlet 86 for selectively isolating that inlet 86 from the manifold 83 and thus from the outlet 84.

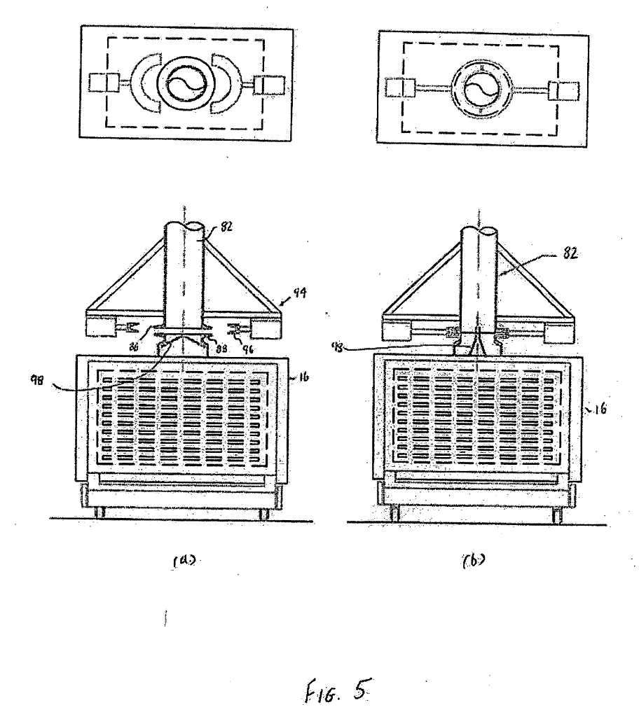

The vapour outlet 88 may be connected to inlet 86 of the condenser conduit system 82 may any suitable means. For example, as illustrated in FIGS. 3 and 4, a flexible bellows connector 92 may be used, the connector 92 having a first flanged end connectable to the inlet 86 of the condenser conduit system 82, and a second flanged end connectable to the vapour outlet 88 of the drying chamber 16. Alternatively, as shown in FIG. 5, a clamping mechanism 94 may be located on the condenser conduit system 82 proximate the inlet 86, the clamping mechanism 94 comprising a plurality of clamps 96 for releasably clamping the flanged inlet 86 and the flanged vapour outlet 88 together. As also shown in FIG. 5, the drying chamber 16 comprises one or more moveable baffles 98 or other closure devices for normally closing the vapour outlet 88. When the flanged inlet 86 is connected to the vapour outlet 88, the baffles 98 are arranged to move from a closed position, as shown in FIG. 5(a), to an open position, as shown in FIG. 5(b), to enable vapour to be exhaust from the drying chamber 16.

Returning to FIGS. 1, 3 and 4, the freeze drying apparatus 10 further comprises an evacuation system 100 for evacuating the drying chambers 16 during the drying process. In this embodiment, the evacuation system 100 comprises one or more vacuum pumps connected to an outlet 102 from the condensation chamber 80 so that vapour drawn from the drying chamber 16 by the evacuation system 100 passes through the condenser conduit system 82 and condensation chamber 80. As illustrated in FIG. 3, a condenser 102 is provided within the condensation chamber 80 for condensing water vapour drawn from the samples during the drying process.

Prior to the connection of the drying chamber 16 to an inlet 86 of the condenser conduit system 82, the isolation valve 90 is closed to prevent ingress of air into the condensation chamber 80. In order to prevent a process disturbance when the isolation valve 90 is opened following connection of the drying chamber 16 to the inlet 86, the drying chamber 16 is preferably pre-evacuated to reduce the pressure within the drying chamber 16 to a pressure similar to that within the condensation chamber 80 and condenser conduit system 82 before the isolation valve 90 is opened.

For pre-evacuating the drying chambers 16, the freeze drying apparatus 10 further comprises a drying chamber pre-evacuation system 104. In the illustrated embodiment, the pre-evacuation system 104 comprises at least one vacuum pump 106 for pre-evacuating each of the drying chambers 16 connected to the condenser conduit system 82. The vacuum pump(s) 106 are connected to an outlet 108 of a manifold 110 of a vacuum conduit system 112. The manifold 110 has a plurality of inlets 114, each inlet 114 being connected to the condenser conduit system 82 between a respective flanged inlet 86 and associated isolation valve 90. The vacuum conduit system 112 further includes a plurality of isolation valves 116, each isolation valve 116 being located between the manifold 110 and a respective inlet 114.

The isolation valves 116 are normally in a closed position to isolate the inlet 86 of the condenser conduit system 82 from the pre-evacuation system 104. Following connection of the drying chamber 16 to an inlet 86 of the condenser conduit system 82, and with the associated isolation valve 90 remaining closed, the isolation valve 116 is opened to enable air to be drawn from the drying chamber 16 by the pre-evacuation system 10. Once the pressure in the drying chamber 16 has been reduced to a pressure similar to that created in the condenser conduit system 82 by the evacuation system 100, the isolation valve 116 is closed and the appropriate isolation valve 90 of the condenser conduit system 82 is opened to expose the drying chamber 16 to the condenser 102 and the evacuation system 100 to start the drying process. The supply of coolant to the drying chamber 16 is stopped, by closing the appropriate valves 78, and the supply of heated fluid to the drying chamber is started, by opening the appropriate valves 74, to heat the frozen samples located within the drying chamber 16 to cause the solid with the samples to sublime into vapour. The vapour is drawn from the drying chamber 16 by the evacuation system 100, the vapour passing through the condenser conduit system 82 to the condensation chamber 80, wherein the vapour condenses on the surface of the condenser 102.

As illustrated in FIGS. 1 and 4, an auxiliary condensation chamber 120, housing an auxiliary condenser 122, may be provided. The auxiliary condensation chamber 120 is connected to an additional outlet 124 from the manifold 83 of the condenser conduit system 82. Each condensation chamber 80, 120 may be selectively isolated from the manifold 83 by a respective isolation valve 126, 128. An auxiliary evacuation system 130 may also be associated with the auxiliary condensation chamber 120. As the condenser 102 becomes full, the auxiliary evacuation system 130 is operated to evacuate the auxiliary condensation chamber 120 to the pressure within the condenser conduit system 82. The isolation valve 126 is then closed, and the isolation valve 128 opened to connect the auxiliary condensation chamber 120 and auxiliary evacuation system 130 to the condenser conduit system. Drying of the samples contained within the drying chambers 16 positioned at the second location 60 may thus be continued whilst the condenser 82 is being defrosted, thereby avoiding shut down of the freeze drying apparatus 10 during condenser servicing.

The drying process is continued until all of the vapour has been emitted from the samples. A pressure rise within the drying chamber 16 may be used to determine the end of the drying process. Once the drying process has been completed, the isolation valve 90 is closed to isolate the drying chamber 16, and the pressure within the drying chamber 16 is gradually returned to atmospheric pressure using an air admittance system 132 illustrated in FIG. 4. The vapour outlet 88 is then disconnected from the inlet 86 of the condenser conduit system 82. The drying chamber 16 is moved from the drying location 60 by the AGV system to a third, unloading position indicated at 134 in FIG. 1. Another moving mechanism is located at the unloading position for raising the door 22 of the drying chamber 16 to enable the blister packs, now containing freeze dried samples, to be transferred from the drying chamber 16 through the slot 48, either manually or using another manipulator, to a packaging station 136.

Once the drying chamber 16 has been unloaded, the AGV system moves the drying chamber to a fourth, washing location, indicated at 138 in FIG. 1, adjacent a washing station 140 for washing and drying the drying chamber 16 in readiness for return to the loading location 18 for loading with another batch of frozen samples. As indicated in FIG. 1, a number of additional drying chambers 16′ may be provided to ensure that there is always at least one drying chamber available to be positioned at the loading location and thereby ensure that drying of frozen samples may be performed in a semi-continuous manner.

While the foregoing description and drawings represent the preferred embodiments of the present invention, it will be apparent to those skilled in the art that various changes and modifications may be made therein without departing from the true spirit and scope of the present invention.

1. A freeze drying apparatus comprising a mobile drying chamber for receiving frozen samples, and a condenser, wherein the drying chamber is moveable between a first location at which frozen samples are loaded thereinto, and a second location at which the chamber is connected to the condenser.

2. The apparatus according to claim 1, further comprising a condenser conduit system comprising an inlet for connection to the drying chamber at the second location, and an isolation valve for selectively isolating the inlet from the condenser for conveying vapour from the drying chamber to the condenser.

3. The apparatus according to claim 2, further comprising a condenser isolation valve for selectively isolating the condenser from the inlet of the condenser conduit system.

4. The apparatus according to claim 3, further comprising an additional condenser for receiving vapour from the condenser conduit system, and an additional condenser isolation valve for selectively isolating the additional condenser from the inlet of the condenser conduit system.

5. The apparatus according to claim 1, further comprising freezing apparatus for freezing a liquid component of samples into a solid to form the frozen samples.

6. The apparatus according to claim 1, further comprising an evacuation system for evacuating the drying chamber at the second location.

7. The apparatus according to claim 6, wherein the evacuation system is configured to evacuate the drying chambers through the condenser.

8. The apparatus according to claim 1, further comprising a thermal control system for controlling the temperature of the frozen samples located within the drying chamber.

9. The apparatus according to claim 8, wherein the thermal control system comprises heating apparatus for heating the frozen samples located within the drying chamber to cause the solid to sublime into vapour.

10. The apparatus according to claim 9, wherein the heating apparatus is connectable to the drying chamber at the second location.

11. The apparatus according to claim 9, wherein the heating apparatus comprises a source of a heated fluid, and means for selectively conveying the heated fluid to the drying chamber.

12. The apparatus according to claim 11, wherein the heated fluid comprises one of silicone oil, and a mixture of water and glycol.

13. The apparatus according to claim 8, wherein the thermal control system comprises cooling apparatus for maintaining the liquid component of the samples located within the drying chamber as a solid.

14. The apparatus according to claim 13, wherein the cooling apparatus is connectable to the drying chamber at the first location.

15. The apparatus according to claim 13, wherein the cooling apparatus is connectable to the drying chamber at the second location.

16. The apparatus according to claim 13, wherein the cooling apparatus comprises a source of a coolant, and means for selectively conveying the coolant to the drying chamber.

17. The apparatus according to claim 16, wherein the coolant comprises a cooled fluid.

18. The apparatus according to claim 16, wherein the coolant comprises one of silicone oil, and a mixture of water and glycol.

19. The apparatus according to claim 6, further comprising a drying chamber pre-evacuation system for at least partially evacuating the drying chamber before the drying chamber is evacuated by the evacuation system.

20. The apparatus according to claim 2, further comprising an evacuation system for evacuating the drying chamber at the second location.

21. The apparatus according to claim 20, further comprising a drying chamber pre-evacuation system for at least partially evacuating the drying chamber before the drying chamber is evacuated by the evacuation system.

22. The apparatus according to claim 21, wherein the drying chamber pre-evacuation system comprises a vacuum pump, and a vacuum conduit system comprising an inlet connected to the condenser conduit system, an outlet connected to the vacuum pump, and an isolation valve for selectively isolating the inlet of the vacuum conduit system from the outlet of the vacuum conduit system.

23. The apparatus according to claim 22, wherein the inlet of the vacuum conduit system is located between the inlet of the condenser conduit system and the isolation valve of the condenser conduit system.

24. The apparatus according to claim 1, wherein the samples are pharmaceutical samples.

25. The apparatus according to claim 1, wherein the mobile chamber is mounted on wheels.

26. The apparatus according to claim 1, comprising a plurality of said mobile chambers.

27. The apparatus according to claim 1, wherein the drying chamber comprises a plurality of shelves for receiving frozen samples.

28. The apparatus according to claim 1, wherein the drying chamber is thermally insulated.

29. The apparatus according to claim 1, wherein the drying chamber has an opening through which the samples are transferred into the chamber from the freezing apparatus.

30. The apparatus according to claim 29, wherein the drying chamber comprises a door for closing the opening, the door having a slot formed therein for exposing part of the opening, and wherein the freeze drying apparatus comprises means for moving the door in a direction transverse to the opening.

31. The apparatus according to claim 30, wherein the moving means comprises means for raising and lowering the door.

32. The apparatus according to claim 31, wherein the drying chamber comprises a flexible screen attached to one end of the door, and a reel located beneath the opening and from which the flexible screen is unwound as the door is raised.

33. The apparatus according to claim 29, wherein the moving means is located at the second location, and comprises means for releasably engaging the door.

34. A freeze drying apparatus comprising freezing apparatus for freezing a liquid component of a sample into a solid, a mobile drying chamber for receiving samples from the freezing apparatus, a condenser, a condenser conduit system for conveying vapour from the drying chamber to the condenser, the condenser conduit system comprising an inlet for connection to the drying chamber, and an isolation valve for selectively isolating the inlet from the condenser, an evacuation system for evacuating the drying chamber; and a thermal control system for controlling the temperature of the samples located within the drying chamber; wherein the drying chamber is moveable between a first location at which samples are transferred from the freezing apparatus to the chamber, and a second location at which the chamber is connected to the inlet of the condenser conduit system.

35. The apparatus according to claim 34, wherein the evacuation system is configured to evacuate the drying chamber via the inlet of the condenser conduit system.

36. The apparatus according to claim 34, wherein the evacuation system is configured to evacuate the drying chamber via the condenser.

37. A freeze drying apparatus comprising a plurality of mobile drying chambers for receiving frozen samples; a condenser, a condenser conduit system comprising a plurality of inlets each being selectively connectable to a respective drying chamber, and a plurality of isolation valves each for selectively isolating a respective inlet from the condenser; an evacuation system for evacuating the drying chambers; and a thermal control system for controlling the temperature of the samples located within the drying chambers; wherein each drying chamber is moveable between a first location at which frozen samples are transferred thereinto, and a second location at which the chamber is connected to an inlet of the condenser conduit system.

38. The apparatus according to claim 37, wherein the evacuation system is configured to evacuate each drying chamber via a respective inlet of the condenser conduit system.

39. The apparatus according to claim 37, wherein the evacuation system is configured to evacuate the drying chambers via the condenser.

40. The apparatus according to claim 37, further comprising a drying chamber pre-evacuation system for at least partially evacuating the drying chambers before the drying chambers are connected to the evacuation system.

41. The apparatus according to claim 40, wherein the drying chamber pre-evacuation system comprises a vacuum pump, and a vacuum conduit system comprising a plurality of inlets each connected to the condenser conduit system between a respective inlet of the condenser conduit system and a respective isolation valve of the condenser conduit system, an outlet connected to the vacuum pump, and a plurality of isolation valves each for selectively isolating a respective inlet of the vacuum conduit system from the outlet of the vacuum conduit system.

42. The apparatus according to claim 37, wherein the thermal control system comprises heating apparatus selectively connectable to each of the drying chambers to heat the samples located therein to cause the solid to sublime into vapour.

43. The apparatus according to claim 42, wherein the heating apparatus is selectively connectable to each of the drying chambers located at the second location.

44. The apparatus according to claim 43, wherein the heating apparatus comprises a source of a heated fluid, and means for selectively conveying the heated fluid to each of the drying chambers.

45. The apparatus according to claim 37, wherein the thermal control system comprises cooling apparatus selectively connectable to each of the drying chambers to maintain the liquid component of the samples located within the drying chambers as a solid.

46. The apparatus according to claim 45, wherein the cooling apparatus is selectively connectable to at least one drying chamber located at the first location.

47. The apparatus according to claim 45, wherein the cooling apparatus is selectively connectable to each of the drying chambers located at the second location.

48. Freeze drying apparatus comprising a drying chamber having an opening formed therein for providing access to the chamber and a door for closing the opening, the door having a slot formed therein; and means for raising the door in a direction transverse to the opening so that the slot exposes part of the opening to permit samples to be loaded into the chamber; the drying chamber comprising a flexible screen attached to a bottom end of the door and a reel located beneath the opening and from which the flexible screen is unwound as the door is raised.
